(19) United States
(12) Patent Application Publication
(10) Pub. No.: US 2015/0051929 A1
(43) Pub. Date: Feb. 19, 2015

(54) AD HOC REPORTING WITH SMART LISTS

(71) Applicant: Microsoft Corporation, Redmond, WA (US)

(72) Inventor: Jennifer F. Ranz, Fargo, ND (US)

(73) Assignee: Microsoft Corporation, Redmond, WA (US)

(21) Appl. No.: 13/970,280

(22) Filed: Aug. 19, 2013

(51) Int. Cl. G06Q 10/00

(52) U.S. Cl. CPC G06Q 10/00
USPC 705/7.11

(57) ABSTRACT

Technologies are generally described for a list designer pane for customizing data lists in an enterprise management application (EMA). An EMA may include tools for managing complex business data. An example tool for managing business data enables the creation of a smart data list which includes customized data records to enable efficient data management and analysis. The EMA provides a list designer pane to facilitate user creation and customization of the new data list. The list designer pane enables selection of data tables and fields to include in a new list, enables creation of relationships between fields and tables included in the new list, and enables filtering of data included in the new list based on user defined criteria. The new list can be created from an existing data list as a template, and can also be created from a blank template.

### BACKGROUND

In a business environment, enterprise management applications may be employed for managing complex business operations. The enterprise management application may be a comprehensive business management solution to enable businesses to increase productivity and manage aspects of the business, such as finances and accounting, human resources, payroll, business intelligence and reporting, manufacturing, supply chain management, inventory, sales, and service and project management as some examples. There may be a large amount of data associated with businesses which may be hosted in many local and remote databases. Users may create data lists from the databases to gather frequently used and needed data, and to present the data in easy to use reports. Users may desire to modify what data is included in the data lists and how the data is reported to create lists that are functional and relevant to the user and the user's projects.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to ad hoc reporting with smart lists. In some examples, a list designer pane for customizing smart data lists may be provided in an enterprise management application (EMA). An EMA may include tools for managing complex business data. An example data management tool may enable creation of smart data lists, which may include customized data records to enable efficient data management and analysis. The EMA may provide a list designer pane to facilitate user creation and customization of the new data list. The list designer pane may enable selection of data tables and fields to include in a new smart data list, may enable definition of relationships between fields and tables included in the new smart data list, and may enable filtering of data included in the new smart data list based on user defined criteria. The new list may be created from an existing data list as a template, and can also be created from a blank template.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example environment where a list designer pane for customizing data lists in an EMA may be provided;

FIG. 2 illustrates an example data list displaying records from a selected database associated with an EMA;

FIG. 3 illustrates an example list designer pane for customizing a data list associated with an EMA;

FIG. 4 illustrates an example calculated field pane and an expression field pane for managing data fields in a list designer pane of an EMA;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing a list designer pane for customizing data lists in an EMA, according to embodiments.

### DETAILED DESCRIPTION

As briefly described above, a list designer pane for customizing smart data lists in an enterprise management application (EMA). The list designer pane may be provided to facilitate management of complex business data within the EMA. The list designer pane may enable selection of data tables and fields to include in a new smart data list, definition of relationships between fields and tables included in the new smart data list, and filtering of data included in the new smart data list based on user defined criteria. The new list may be created from an existing data list as a template, and may also be created from a blank template.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

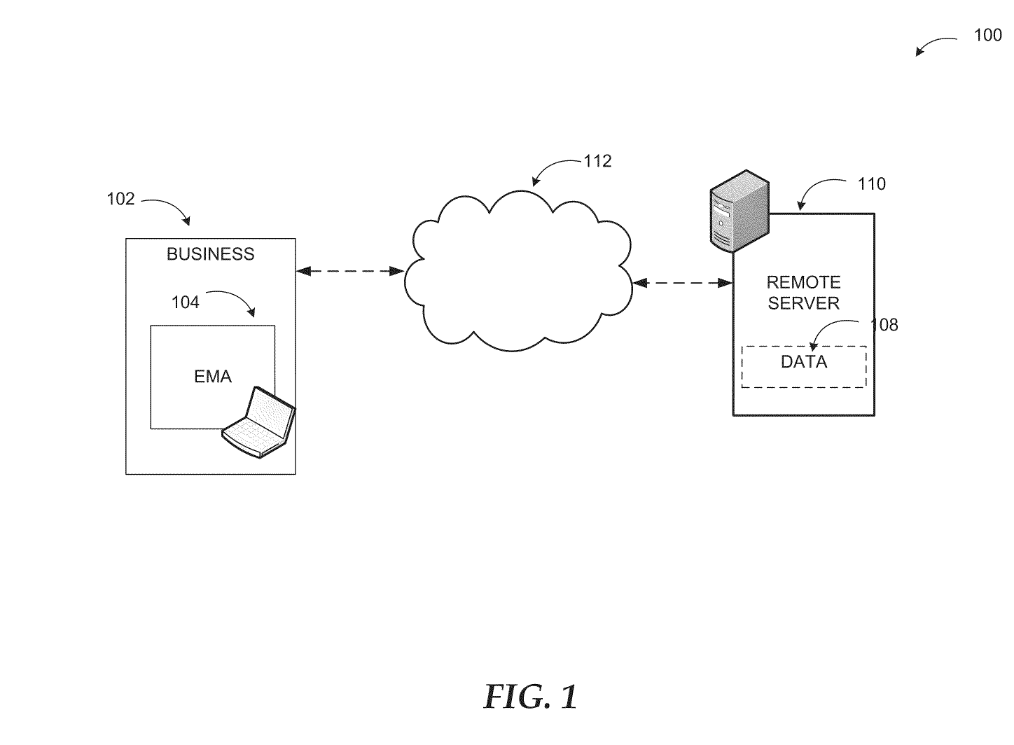

FIG. 1 illustrates an example environment where a list designer pane for customizing data lists in an EMA may be provided, according to some embodiments herein. As illustrated in diagram 100, a business 102 may utilize an EMA 104 which may be a comprehensive business management solution to enable businesses to increase productivity and manage many complex aspects of the business, including financial management, accounting, human resources, payroll, business intelligence, reporting, manufacturing, supply chain management, inventory, sales, and service and project management as some examples. Tools associated with the EMA 104 may enable users to access and analyze real-time data about aspects of the business operations, finances, resources, and decision-defining information. Data 108 related to the business operations, finances, and other aspects may be maintained by multiple data stores at a remote server 110, and may be accessed by individual EMAs executed on a plurality of client devices over a network 112, such as a cloud based network.

An example tool provided by the EMA 104 for accessing and analyzing data related to the business may be a list query. The list query may enable data to be gathered from one or more remote data stores based on user defined criteria, and the gathered data may be reported in a user customizable data list, which may be a smart list, to enable efficient and manageable data analysis. The user may customize databases from which to gather data, what type of data to gather, and how to present the data in the list. In an example embodiment, a list designer pane may be provided in order to facilitate customization of the list employing tools associated with the EMA 104.

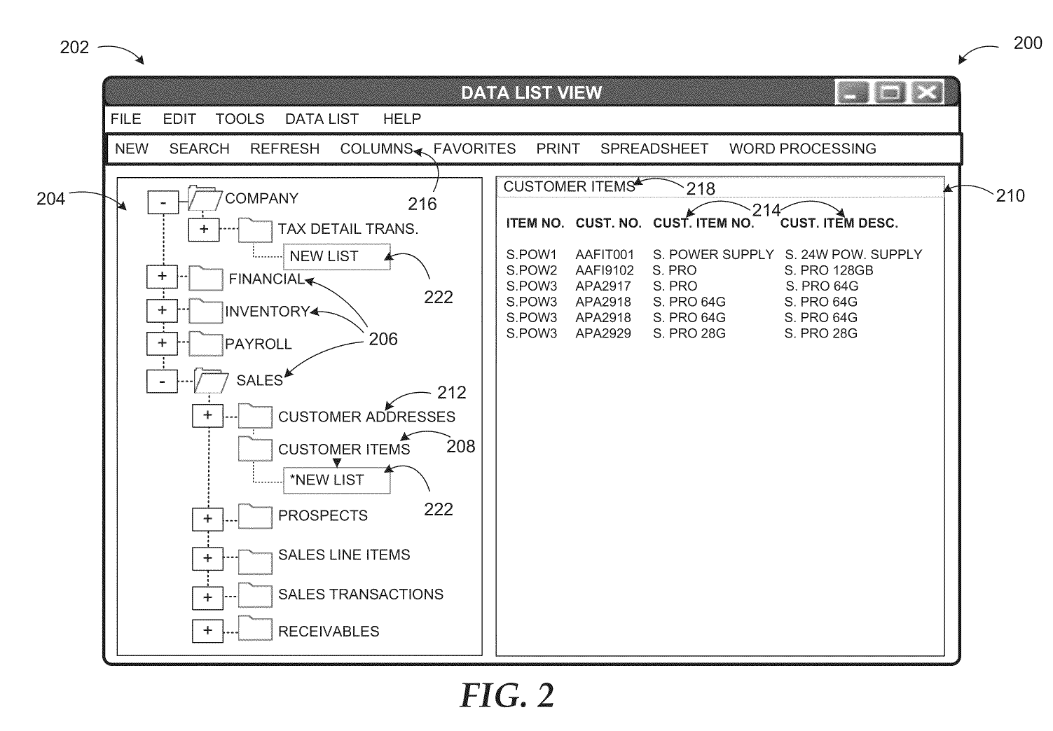

FIG. 2 illustrates an example data list displaying records from a selected database associated with an EMA, according to some embodiments herein. As illustrated in diagram 200, within an EMA, a list view 202 may be presented where a user may view one or more data lists. The list view 202 may include a menu pane 204 and a list pane 210. The list pane 210 may display a user customized list of data fields from a selected database. The menu pane 204 may display a list of available databases, and may also display existing series 206 of data, list folders 212 including existing lists, and one or more data lists 208 that a user may select. A series 206 may be a folder that includes groups of related lists. Example series for an EMA company database may include financial, inventory, payroll, and sales series. The example sales series may include one or more list folders 212 such as a customer addresses folder, and a prospects folder. Each list folder may include one or more related data lists 208, such as a customer items list. When an existing data list is selected from the menu pane 204, the data list 218 may be displayed in the list pane 210. The displayed data list 218 may include a number of columns representing selected fields 214 from the database and displaying data for each field.

In an example embodiment, a user may desire to create a new data list to view and analyze data from the company database. The user may execute a list query to create the new data list from a selected database to be displayed in the list view 202. A new button 222 may be displayed on the menu pane 204 to enable the user to create the new data list. The user may select to create the new list from an existing list by selecting an existing list on the menu pane 204 and selecting the new button 222 while the existing list is highlighted. The selected existing list may serve as a template for the new list. The user may also select to create a new list without using an existing list as a template by selecting the new button 222 without making a selection in the menu pane 204. The new button 222 may be a textual indicator or a graphical indicator, such as an asterisk, for example. Other similar graphical, textual, highlighting and animation schemes may also be used to indicate an option to create a new data list. Additionally, a keyboard shortcut entry may be employed to create a new list, such as “Alt+N,” for example. The keyboard shortcut entry may be customizable at the EMA level, and also by a user. Additionally, a tooltip that indicates “create a new list” may be displayed in response to a hover over a selected list and/or the new button 222.

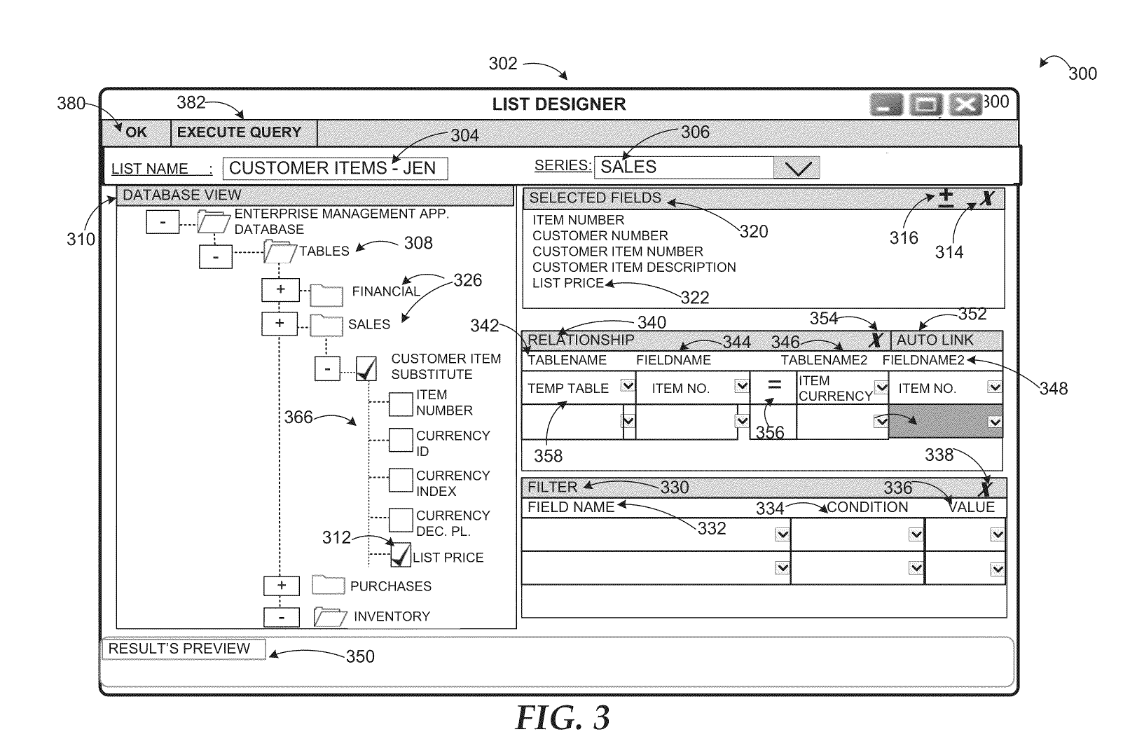

In an example scenario for creating a new data list from an existing list as a template, a user may select an existing list from the menu pane 204 and may select the new button 222. The new button 222 may become automatically enabled when one of a series, a list folder or a list is highlighted. Upon selection of the new button 222, the selected list may be presented as a template list, and a list designer pane may be provided to enable the user to customize the new data list, as will be discussed in more detail below in conjunction with FIG. 3. The list designer pane may prompt the user to provide a list name and series name. The provided list name may become the list folder name that may be displayed in the menu pane 204 of the list view 202. The series name may default to the series that includes the list selected by the user. When the new data list is created from the existing list as a template, the list designer pane may be automatically populated with data from the existing list, and the user may be able to customize the list employing the list designer pane. For example, the user may select additional fields to add within the list designer pane, and the additional fields may be added to existing displayed fields in the new data list. When the user saves the new data list, the selected fields may be shown as columns of the list by default when the list is subsequently selected.

In an example scenario for creation of a new data list without using an existing list as a template, a user may select and highlight a series folder in the menu pane 204 of the list view 202, and the user may select the new button (or otherwise indicate to create a new data list). A new data list may be created within the series folder, and the list designer pane may be displayed to enable the user to customize the new data list. When the list designer window is initially displayed, the user may be similarly prompted to provide a list name and a series name. The user may provide a list name in the list name field, and the series name may default to the series that was highlighted when the new button was selected. Since a new data list is being created without employing a template list, no other database information may be automatically provided, and a database view pane may be displayed with the list designer pane to enable the user to select information to be included in the new data list. The database view pane may include selectable options such as a database from which to access and retrieve data, and tables and fields to be included in the new data list.

In a system according to embodiments, after customization of a list query employing the list designer pane, the new data list may be created and displayed in the list pane 210 of the list view 202. Existing EMA list functionalities may be enabled within the new data list, such as refreshing, saving, exporting, and printing the list, as some examples. A column button 216 may also be presented, and may be selected to enable columns to be added, removed, and rearranged within the new data list. Additionally, existing go-to functionality from an existing list may carry over to the new data list and may be fully functional. The user creating the new data list may also be automatically granted permission to view the new data list, and the user creating the list may define other security or permissions for users who may also view the new data list.

FIG. 3 illustrates an example list designer pane for customizing a data list associated with an EMA, according to some embodiments herein.

As illustrated in diagram 300, a list designer pane 302 may be displayed upon selection by a user to create a new list to enable the user to customize the newly created list. In an example embodiment, an example list designer pane 302 may include a list name field 304 and a series name field 306. As previously discussed, the user may provide a list name in the list name field 304. The series name field 306 may determine where the new list will be displayed in the menu pane of the list view. The series name field 306 may automatically default from the series associated with a selected list in the list view, and the user may also customize the series name field 306 may to select an existing series to add the new list to.

In a system according to embodiments, the list designer pane 302 may include one or more data sections for selecting, interacting with and customizing data for the new list, such as a database view section 310, a selected fields section 320, a relationships section 340, a filter section 330, and a results section 350. The database view section 310 may display one or more tables 308 and/or views associated with a selected database. Each table 326 may include one or more fields 366 that the user may select to add to the new list, and the tables and fields may be presented in a tree structure within the database view section 310. The database for the database view section 310 may be manually selected by the user, and in other embodiments, the selected database may default to a database that is associated with the EMA when the user is logged in. The tables and fields may be displayed in a default order as defined by the EMA, and the display order may also be customizable by the user. Additionally, the fields may be displayed in an alphabetical order and/or a numerical order. Furthermore, the tables and fields in the database view section 310 may be displayed based on a security or permission of the user. For example, only tables and views that the user has permission to access may be displayed in the database view section 310. Permissions and security settings may be defined and configurable within the EMA.

In an example embodiment, each of the tables and fields displayed in the database view section 310 may include a checkbox 312 adjacent to each table and/or field. The user may select a table and/or field to add to the new list by marking the checkbox 312. A check may be displayed within the checkbox to indicate that a table and/or field has been selected for addition to the list. When a field is selected in the database view section 310, the selected field may be added into the selected fields section 320 of the list designer pane 302. For example, the checkbox 312 adjacent to the list price field may be selected in the database view section 310, and the list price field 322 may be added to the selected fields section 320.

In a system according to embodiments, the selected fields section 320 may display a list of fields to be included as columns in the new list. A default list of fields from an existing list may be displayed when the user selects to create a new list from a template existing list. For example, a user may set up a default list of columns that are displayed for a type of list query and an order in which they appear. The selected fields section 320 may also display one or more fields the user selects to add from the database view section 310, such as the list price field 322. A field may be added and removed to the selected fields section 320 as a checkbox adjacent to the field is marked and unmarked in the database view section 310. Additionally, a field may be selected and removed from the field view section employing a remove button 314 presented with the selected fields section 320. The remove button 314 may be a graphical or textual icon. The user may select a field in the selected fields section 320, and while the field is selected, the remove button 314 may be selected to delete the field from the selected fields section 320. The user may select and remove two or more fields concurrently by selecting the remove button 314 while the two or more fields are selected. When a field is removed using the remove button 314 the checkbox adjacent to the field in the database view section 310 may become unchecked in response.

In some embodiments, a selected field from a first table may have a same name as another field from a second table. When two or more fields having the same name are added to the selected fields section 320, the fields may be displayed including a table name and a field name to distinguish the duplicate fields. Within the selected fields section 320, fields may be displayed in an order in which the user selects the fields from the database view section 310. If a field is de-selected in the database view section 310, the corresponding field may be removed in the selected fields section 320, and remaining fields may be shifted up. Furthermore, the selected fields section 320 may include a calculated field button 316 to enable calculated fields to be created within the list designer pane 302 in the selected fields section 320.

In another example embodiment, the relationships section 340 may display one or more tables selected from the database view section 310, and may allow a relationship to be defined between the tables that are selected in the database view section 310. An autolink 352 option may be presented within the relationships section 340 to enable a relationship to be automatically defined. A remove button 354 may also be presented to enable an existing relationship to be deleted.

In an example embodiment, a relationship table may be provided to enable a relationship to be defined between the tables that are selected in the database view section 310, where the relationship is an established association between two or more tables based on common fields from more than one table. The relationships table may include a first table name column 342 (TableName), a first field name column 344 (FieldName), a second table name column 346 (TableName2), and a second field name column 348 (FieldName2), and may also include an operator field 356 to define the relationship between the tables. Each field in the corresponding column may be a drop down list field where a table or field may be selected. Tables that may appear in the first and second table name drop down list may be tables that have been selected in the database view section 310. If the new list was created from an existing list as a template, a template table 358 may be presented as a table option in the drop down list. The field drop down lists may include fields associated with the table selected in a corresponding table drop down list. The operator field 356 may also include a drop down list presenting operations for defining the relationship, such as left, equal and cross join operations. The user may select the operation from the drop down list to define the relationship.

In another example embodiment, the autolink 352 option may be employed to automatically create a relationship between tables that have been included in the selected fields section 320. In order to create an automatic relationship, the autolink 352 may identify common field names within primary keys of the tables, where the primary keys may identify each record in the table, and the autolink 352 may link two or more fields together if there are multiple fields that are the same within the primary key. Autolink 352 may also initially create an equal relationship, and a user may edit the automatically created relationship by modifying a field that was added with the autolink 352. Furthermore, if no common fields are identified, a warning message may be displayed indicating that a relationship cannot be automatically created, and the user may need to define the relationship. In another embodiment, if an existing list is used to create the new list, the autolink 352 may link the template table and the newly added table(s) to create a relationship.

After an automatic relationship has been created with the autolink 352, the first table name column and the second table name column, and the first field name column and the second filed name column may be automatically populated so that the user can view the automatically created relationship. An example displayed relationship may be Customer Master & Customer Master Address−CUSTOMER ID=CUSTOMER ID.

In a further embodiment, a relationship may be deleted by selecting one of the fields in the relationships section 340, and selecting the remove button 354. If multiple fields in a table are linked, only the highlighted field may be removed. Additionally, if a table that is part of a defined relationship is removed by the user in the database view section 310, a warning message may be presented to indicate that the relationship will also be removed. The user may select to allow the relationship to be removed, or the user may cancel the removal, and the relationship and the table may remain.

In another example embodiment, a filter section 330 may allow the user to restrict out results of the list query when creating the new list. For example, the filter section 339 may present a field name field 332 which may be a drop down list field that may display a list of the fields included in the selected fields list. A condition field 334 may also be presented, and the condition field 334 may be a drop down list with conditions for including or excluding a field from the query. Example conditions may be: like, not like, is, is not, is any of, is none of, more than, more than or equal to, less than, and less than or equal to. A value field 336 may also be presented, and the value field 336 may be customizable by the user. The user may enter a value for the value field 336 to filter the field based on the defined value. If a field is removed that is part of the filter, the filter may remain. If a table is removed that is part of the filter, the filter may be automatically removed. If a filter is to be automatically removed, a warning message may be provided to enable the user to accept or cancel the automatic removal of the filter.

In a system according to embodiments, the list designer pane 302 may also display an OK button 380 that the user may select in order to close the list designer pane 302 and to execute the list query to create the new list in the list view. Upon selection of the OK button 380, before closing and saving the new list, the OK button 380 may be configured to validate that a table relationship exists for each field in the selected fields section 320. If a relationship does not exist, an error message may be displayed to indicate that a table relationship may need to be defined before the list can be saved. Selection of the OK button 380 may also validate that a list name has been entered, and if the list name field is blank or invalid, an error message may be displayed to indicate that the user may need to provide a list name before the list can be saved. The list designer pane 302 may also include an execute query button 382 that may execute a selected statement and may display the results of the query in a results section.

In an example embodiment, a user may navigate through the list designer pane 302 employing keyboard entries, such as employing arrows, a spacebar, and a tab action to navigate to the different sections of the list designer pane 302. For example, up and down arrows may allow the user to move up and down within each section of the list designer pane 302. Right and left arrows may allow the user to expand and collapse folders and tables within each section, such as tables displayed in the database view section 310 tree. A space bar may enable selection of an item, such as marking and unmarking a checkbox in the database view section 310. A tab entry may navigate through the section of the list designer pane 302. An example tab sequence may be: the OK button 380, the execute query button 382, the database view section 310, the selected fields section 320, the relationships section 340, and the filter section 330.

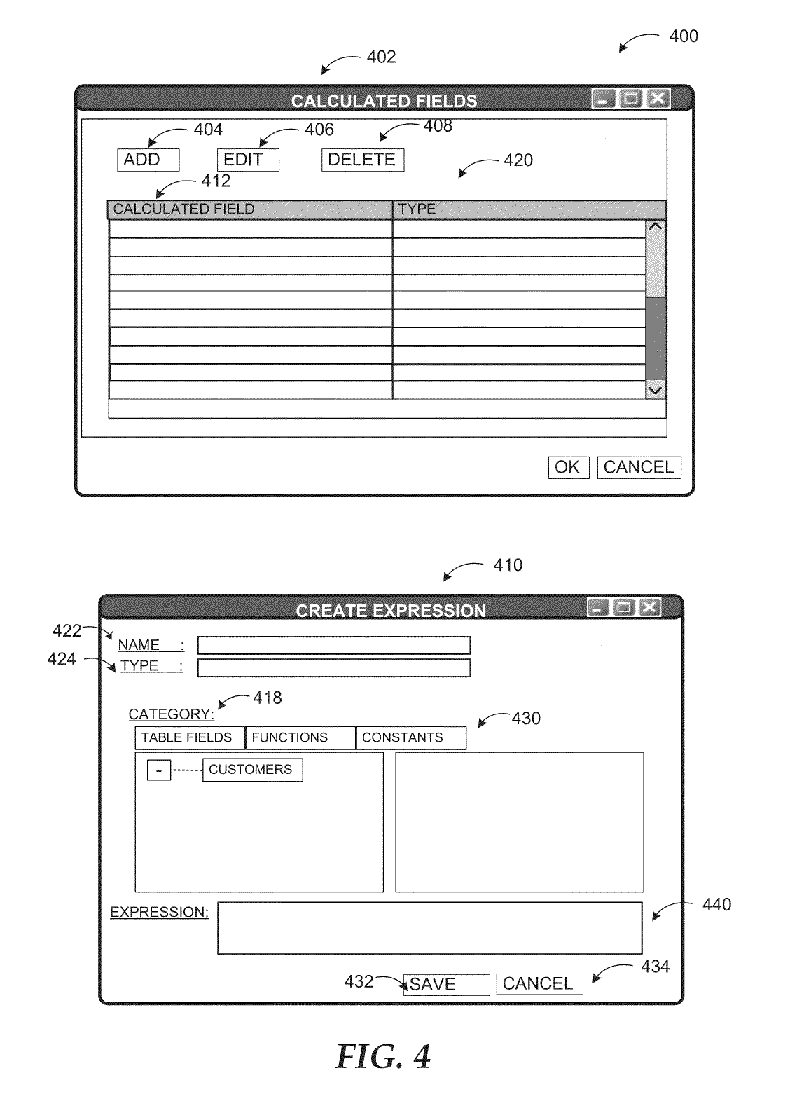

FIG. 4 illustrates an example calculated field pane and an expression field pane for managing data fields in a list designer pane of an enterprise management application (EMA).

As discussed above, a selected fields section of a list designer pane may include a calculated field button to enable calculated fields to be created within the list designer pane in the selected fields section. Diagram 400 illustrates an example calculated field pane 402 that may be displayed in response to selection of the calculated field button on the selected fields section of the list designer pane. The calculated field pane may display a list of calculated fields for the list query. The calculated field pane may list the calculated fields that have been created along with a type of the field.

From the calculated field pane 402, a new expression may be created by selection of an add button 404, and an existing expression may be modified by selecting a displayed field in the list designer pane and selecting an edit button 406. A delete button 408 may also be presented on the calculated field pane to delete a selected calculated field. Upon selection of the add button 404 or the edit button 406, an expression pane 410 may be displayed. The expression pane 410 may display a name field 422 and a type field 424, where the name field 422 may be a user-defined name of the calculated field. The type field 424 may be a drop down list that may enable selection of the type of field and format that the field may display in the list. Example types may include a currency, a date, an integer, a long integer, and a string.

An expression box 440 may store a calculation, and the expression box 440 may be populated automatically employing selections from a category box 418. Additionally the expression box 440 may be populated by calculation by the user. The category box 418 may display a list of tables that have been selected for a list query. The category box 418 may also display available operators and common function types for performing a calculation (430). Example function types may include arithmetic, text, date and time, math, and aggregate. For example, if a table is selected in the category box 418, a list of fields associated with the table may be displayed. When a function type is selected in the category box 418, available functions associated with the selected function type may be displayed. The following table may provide some example functions associated with selected function types:

| | |
|---|---|
| Arithmetic | + —Allows numbers to be added together, also allows string fields to |
| | be concatenated. |
| | Field + Field |
| Arithmetic | − —Calculates the difference between numbers. |
| | Field − Field |
| Arithmetic | *—Allows numbers to be multiplied together |
| | Field * Field |
| Arithmetic | /—Allows numbers to be divided |
| | Field/Field |
| Text | Left—Returns a string containing a specified number of characters from |
| | the left side of a string. |
| | Left(Fields, #) |
| Text | Len—Returns an integer containing either the number of characters in |
| | a string or the number of bytes required to store a variable. |
| | Len(Fields) |
| Text | LCase—displays the string field in lowercase letters |
| | LCase(Field) |
| Text | LTrim—Returns a string containing a copy of a specified string with |
| | no leading spaces (LTrim), |
| | no trailing spaces (RTrim), or no leading or trailing spaces (Trim). |
| | LTrim(Field) |
| Text | Replace—Returns a string in which a specified substring has been |
| | replaced with another substring a specified number of times. |
| | Replace(Field, “old”, “new”) |
| Text | RTrim—Returns a string containing a copy of a specified string with |
| | no leading spaces (LTrim), |
| | no trailing spaces (RTrim), or no leading or trailing spaces (Trim). |
| | RTrim(Field) |
| Text | Space—Returns a string of repeated spaces |
| | SPACE (integer_expression) |
| Text | Str—Returns character data converted from numeric data. |
| | STR (float_expression, length, decimal) |
| Text | Stuff—Inserts a string into another string. It deletes a specified length |
| | of characters in the first string at the start position and then inserts the |
| | second string into the first string at the start position. |
| | STUFF (character_expression, start, length, replaceWith_expression |
| Text | Substring |
| Text | Trim—Returns a string containing a copy of a specified string with no |
| | leading spaces (LTrim), |
| | no trailing spaces (RTrim), or no leading or trailing spaces (Trim). |
| | Trim (Field) |
| Text | UCase—displays the string field in uppercase letters |
| | UCase (Fields) |
| Text | & ——Allows string fields to be concatenated |
| | Field & Field |
| Text | Case—Returns one of two objects, depending on the evaluation of an |
| | expression. |
| | CASE input_expression |
| | WHEN when_expression THEN result_expression |
| | ELSE else_result_expression |
| | END |
| Text | Cast—Returns field as another data type |
| | CAST (expression AS data_type) |
| Date&Time | DateAdd—Returns a Date value containing a date and time value to |
| | which a specified time interval has been added. |
| Date&Time | DateDiff—Returns a Long value specifying the number of time |
| | intervals between two Date values. |
| Date&Time | DatePart—Returns an Integer value containing the specified component |
| | of a given Date value. |
| Date&Time | Day—Returns an Integer value from 1 through 31 representing the day |
| | of the month. |
| Date&Time | Month—Returns an Integer value from 1 through 12 representing the |
| | month of the year. |
| Date&Time | MonthName—Returns a String value containing the name of the |
| | specified month. |
| Date&Time | Year—Returns an Integer value from 1 through 9999 representing the |
| | year. |
| Math | Abs—Returns the absolute value of a number. |
| | Abs (Field) |
| Math | Round—Rounds a double-precision floating-point value to the nearest |
| | integer. |
| | Round (Field) |
| Aggregate | Avg—Returns the average of all non-null values from the specified |
| | expression. |
| | Avg (Field) |
| Aggregate | Count—Returns a count of the values from the specified expression. |
| | Count (Field) |
| Aggregate | Max Returns the maximum value from all non-null values of the |
| | specified expression. |
| | Max (Field) |
| Aggregate | Min Returns the minimum value from all non-null values of the |
| | specified expression. |
| | Min (Field) |
| Aggregate | Sum Returns a sum of the values of the specified expression. |
| | Sum (Field) |

A save button 432 may also be presented with the expression pane 410, and selection of the save button 432 may save the calculated field and close the expression pane 410. When the save button 432 is selected, the calculated field may also be validated to ensure the syntax of the expression is correct. If the calculated field is not correct, a warning message may be provided to indicate the calculated field is invalid. Additionally, a cancel button 434 may be provided, and selection of the cancel button may close the expression pane and the calculated field pane and not save the calculated field.

The example applications, devices, user interfaces, and elements of those user interfaces, as well as functionalities, discussed in FIGS. 1-4 are provided for illustration purposes only. Embodiments are not limited to the configurations and content shown in the example diagrams, and may be implemented using other applications, devices, user interfaces, and elements of those user interfaces, as well as functionalities employing the principles described herein

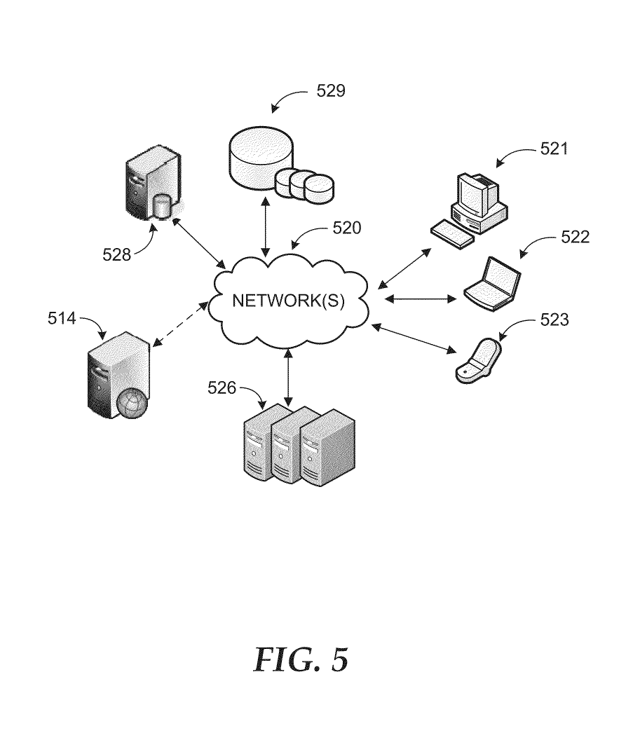

FIG. 5 is an example networked environment, where embodiments may be implemented. In addition to locally installed applications, such as enterprise management application (EMA) 622 discussed below, a list designer pane may also be employed in conjunction with hosted applications and services that may be implemented via software executed over one or more servers 506 or individual server 508. A hosted service or application may communicate with client applications on individual computing devices such as a handheld computer 501, a desktop computer 502, a laptop computer 503, a smart phone 504, a tablet computer (or slate), 505 (‘client devices’) through network(s) 510 and control a user interface presented to users.

Client devices 501-505 are used to access the functionality provided by the hosted service or application. One or more of the servers 506 or server 508 may be used to provide a variety of services as discussed above. Relevant data may be stored in one or more data stores (e.g. data store 514), which may be managed by any one of the servers 506 or by database server 512.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to a list designer pane for customizing data lists in an enterprise management application. Furthermore, the networked environments discussed in FIG. 5 are for illustration purposes only. Embodiments are not limited to the example applications, modules, or processes.

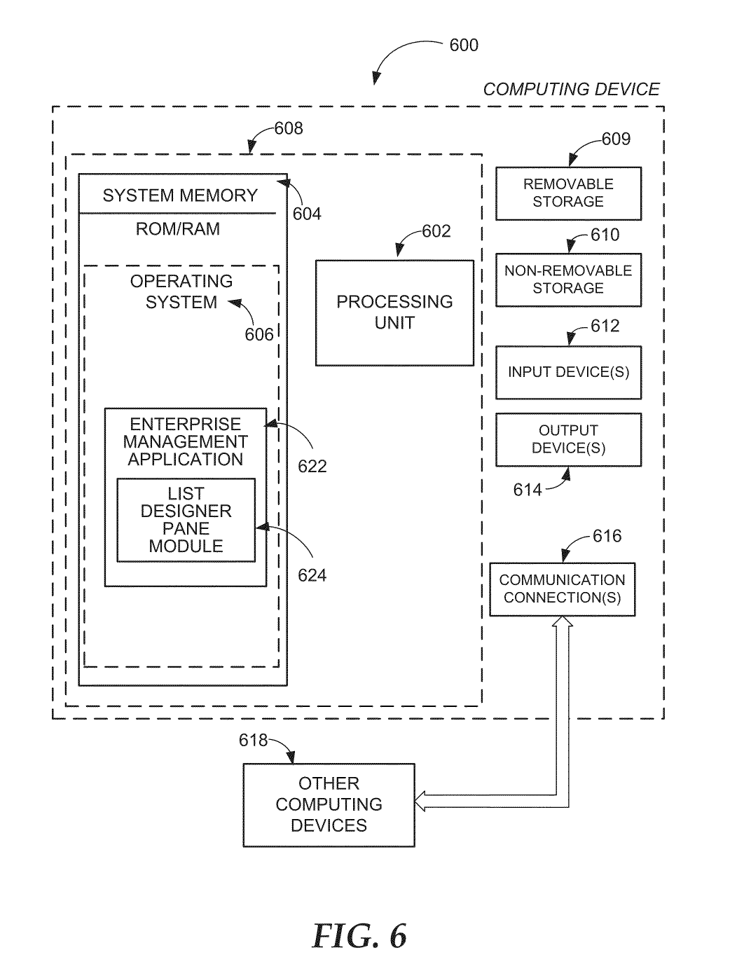

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any touch and/or gesture enabled device in stationary, mobile, or other form such as the example devices discussed in conjunction with FIGS. 1-4 and may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS®, WINDOWS MOBILE®, or WINDOWS PHONE® operating systems from MICROSOFT CORPORATION of Redmond, Wash. The system memory 604 may also include one or more software applications such as program modules 606, enterprise management application (EMA) 622 and list designer pane module 624.

The list designer pane module 624 may operate in conjunction with the operating system 605 or enterprise management application (EMA) 622 to collect data from a database and to display options for customizing reporting of the data in a user customized list. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 615 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

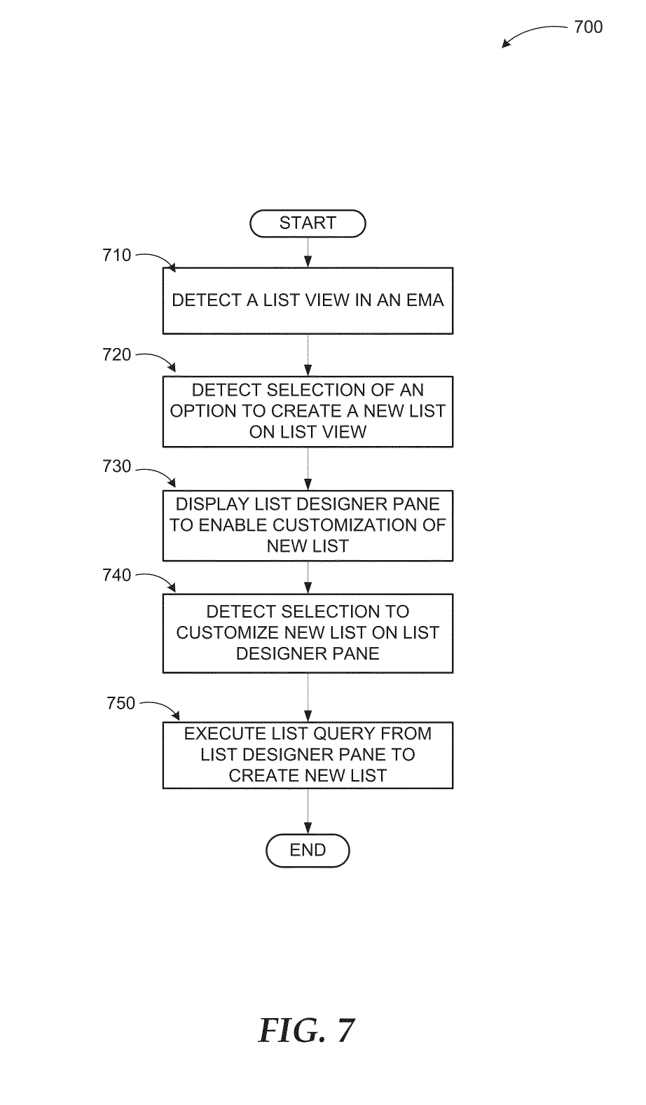

FIG. 7 illustrates a logic flow diagram for a process of providing ad hoc reporting with smart lists in an enterprise management application (EMA), according to embodiments. Process 700 may be implemented as part of an application or an operating system.

Process 700 begins with operation 710, “DETECT A LIST VIEW IN AN EMA,” where a list view may display a menu pane and a list pane. The menu pane may display a series of existing data lists, and the list pane may display a selected existing data list.

Operation 710 is followed by operation 720, “DETECT SELECTION OF AN OPTION TO CREATE A NEW LIST ON THE LIST VIEW,” where a user may select to create a new data list based on an existing list as a template, and based on a blank template. A new button may be displayed to enable the user to select to create the new list.

Operation 720 is followed by operation 730, “DISPLAY LIST DESIGNER PANE TO ENABLE CUSTOMIZATION OF THE NEW LIST,” where a list designer pane may be displayed upon detection of selection to create a new list. The list designer pane may include a database view section where the user may select to add tables and/or fields to a selected fields section of the list designer pane to include in the new list.

Operation 730 is followed by operation 740, “DETECT SELECTION TO CUSTOMIZE NEW LIST ON LIST DESIGNER PANE,” where the user may customize the new list in the list designer pane. The user may add and remove fields form the selected fields section, define relationships between tables and fields included in the selected fields section, and may filter data to be included in the new list based on user defined criteria.

Operation 740 is followed by operation 750, “EXECUTE LIST QUERY FROM LIST DESIGNER PANE TO CREATE NEW LIST,” where the user may select to create the customized new list by selecting an execute query option on the list designer pane. The list query may be executed and the new list may be displayed in the list pane of the list view.

The operations included in process 700 are for illustration purposes. Providing a list designer pane for customizing data lists in an enterprise management application according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to provide ad hoc reporting with smart lists in an enterprise management application (EMA), the method comprising:
detecting activation of a list view in the EMA;
detecting selection of an option to create a new list on the list view;
displaying a list designer pane to enable customization of the new list;
detecting one or more selections to customize the new list on the list designer pane; and
executing a list query from the list designer pane to create the new list.

2. The method of claim 1, further comprising:
displaying a database view section in the list designer pane.

3. The method of claim 2, further comprising:
detecting selection of a database to associate with the list designer pane; and
displaying a list of tables and views from the selected database in the database view section, wherein each table in the list of tables includes one or more fields associated with each table.

4. The method of claim 3, further comprising:
detecting selection of at least one field from the database view section.

5. The method of claim 4, further comprising:
adding the at least one selected field from the database view section to a selected fields section of the list designer pane, wherein each field in the selected fields section is a column to be displayed in the new list.

6. The method of claim 5, further comprising:
displaying a list name field in the list designer pane to enable a list name to be defined for the new list.

7. The method of claim 1, further comprising:
automatically providing a series name associated with the new list in a series name field of the list designer pane, wherein the series name is a category associated with the new list.

8. The method of claim 1, further comprising:
displaying a relationships section in the list designer pane to enable a relationship to be defined between two or more tables associated with two or more fields included in a selected fields section.

9. The method of claim 8, further comprising:
enabling selection of an autolink option in a relationships section to automatically define a relationship between two or more tables associated with two or more fields included in the selected fields section.

10. The method of claim 9, further comprising:
automatically defining a relationship between the two or more tables associated with two or more fields included in the selected fields section based on identification of a common fields name in a primary key associated with each table.

11. The method of claim 1, further comprising:
upon execution of the list query to create the new list, displaying the new list in a list pane of the list view.

12. A computing device to provide ad hoc reporting with smart lists in an enterprise management application (EMA), the computing device comprising:
a memory;
a processor coupled to the memory, the processor executing the EMA, wherein the processor is configured to:
detect activation of a list view in the EMA;
detect selection of an option to create a new list on the list view;
display a list designer pane to enable customization of the new list;
display a database view section in the list designer pane, wherein the database view section displays one or more tables and one or more fields available for addition to the list designer pane;
detect one or more selections to customize the new list on the list designer pane; and
execute a list query from the list designer pane to create the new list.

13. The computing device of claim 12, wherein the processor is further configured to:
detect selection of at least one field from the database view section;
add the selected field from the database view section to a selected fields section of the list designer pane, wherein each field in the selected fields section is a column to be displayed in the new list; and
enable removal of a field from the selected fields section by selection of a removal button displayed on the selected fields section of the list designer pane.

14. The computing device of claim 13, wherein the processor is further configured to:
detect selection of an option to create the new list from an existing list displayed on the list view as a template; and
automatically populate the selected fields section with one or more fields from the existing list template.

15. The computing device of claim 13, wherein the processor is further configured to:
provide a filter section in the list designer pane to enable data associated with the one or more fields in the selected fields section to be restricted.

16. The computing device of claim 13, wherein the processor is further configured to:
upon detection of a selection of a calculate field option displayed on the selected fields section, provide a calculated field pane to enable a user to one of: create a new calculated field and modify an existing calculated field.

17. The computing device of claim 12, wherein the processor is further configured to:
provide an expression pane, wherein the expression pane includes an expression box to store a calculation, a category box to display a list of tables and fields to be included in the new list and available functions to perform a calculation.

18. A computer-readable memory device with instructions stored thereon to provide ad hoc reporting with smart lists in an enterprise management application (EMA), the instructions including:
detecting activation of a list view in the EMA;
detecting selection of an option to create a new list on the list view;
displaying a list designer pane to enable customization of the new list;
displaying a database view section in the list designer pane, wherein the database view section displays one or more tables and one or more fields available for addition to the list designer pane;
detecting a selection to add at least one field to a selected fields section of the list designer pane;
detecting one or more selections to customize the new list on the list designer pane; and
executing a list query from the list designer pane to create the new list upon selection of an execute query option on the list designer pane.

19. The computer-readable memory device of claim 18, wherein the instructions further comprise:
upon selection of the execute query option, validating that a relationship exists for each field in the selected fields section; and
validating that a list name has been provided for new list in a list name field on the list designer pane.

20. The computer-readable memory device of claim 18, wherein instructions further comprise:
upon creation of the new list, enabling existing EMA list functionalities within the new list, including one or more of: refreshing the new list, saving the new list, exporting the new list, printing the new list, and adding, removing, and rearranging columns on the new list.
